(19) United States
(12) Patent Application Publication
(10) Pub. No.: US 2003/0107259 A1
(43) Pub. Date: Jun. 12, 2003

(54) Integral assembly for connecting a hub and other members to the suspension of a motor vehicle wheel

(75) Inventor: Andreas Rutter, Pinerolo (IT)

Correspondence Address: MERCHANT & GOULD PC, P.O. BOX 2903, MINNEAPOLIS, MN, 55402-0903, US

(73) Assignee: SKF INDUSTRIE S.P.A., Torino (IT)

(21) Appl. No.: 10/315,507

(22) Filed: Dec. 9, 2002

(30) Foreign Application Priority Data
Dec. 10, 2001 (IT) TO2001U000229

(51) Int. Cl. B60B 19/00

(52) U.S. Cl. 301/6.8

(57) ABSTRACT

An integral assembly for a motor vehicle wheel comprises a metal mounting element (20) and a bearing-hub unit (10). The mounting element (20) integrally forms:

a radial plate portion (21) with holes (25) for fastening to the suspension strut of a motor vehicle and mounting lugs (23, 24) for brake calipers; and

an axial tubular portion (22) which forms a cylindrical seat (23).

The bearing-hub unit (10) includes a hub (11) mounted rotatably in a bearing having a non-rotating, outer ring (17), locked into the cylindrical seat (23) by means of end portions (17a, 17b) of the outer ring (17), which have been cold formed against respective lateral surfaces (22a, 22b) of the axial tubular portion (22).

### DESCRIPTION

The present invention relates to an integral assembly for connecting a hub and other members to the suspension of a motor vehicle wheel.

The oldest conventional solutions for connecting the wheel hub and brake calipers to the suspension strut in a motor vehicle provide for the brake caliper mounts to be formed on the strut. According to a more recent solution, such mounts are formed in the projecting lugs of a metal plate which is interposed and fixed by means of connecting bolts between the bearing-hub unit and the suspension strut of the wheel.

An integral assembly for supporting the hub of a motor vehicle wheel is known from U.S. Pat. No. 4,582,338. A bearing-hub assembly comprises an inner ring, an outer ring and rolling elements inserted between the rings, which are provided with respective integral flanges. The flanges formed integrally with the non-rotating ring of the bearing also integrally forms a pair of laterally projecting lugs for connection to the brake calipers and an arm which projects downwards comprising a connection seat for a suspension ball joint.

Since the mounting lugs for the brake calipers are made integrally with the flange of one of the bearing rings, said ring absorbs the stresses generated during braking, with a consequent negative impact on the service life of the bearing.

In U.S. Pat. No. 5,927,820 a metal plate-like element having a pair of lugs for connection to the brake calipers is connected peripherally to the flange of the non-rotating ring of the bearing. The plate element and the flange of the non-rotating ring of the bearing are made angularly integral with one another by means of pins engaging in respective holes formed partly along the edge of the applied element and partly along the mating edge of the non-rotating ring.

The object of the present invention is to provide an integral assembly which permits a reduction in costs for the production, the fitting of a bearing-hub unit and of brake calipers to the suspension strut and connection to steering or suspension members.

Said and other objects and advantages, which will be better understood below, are achieved according to the present invention by an integral assembly having the features defined in the attached claims.

The structural and functional features of some preferred, but non-limiting, embodiments of an integral assembly according to the present invention will now be described: reference is made to the attached drawings, in which:

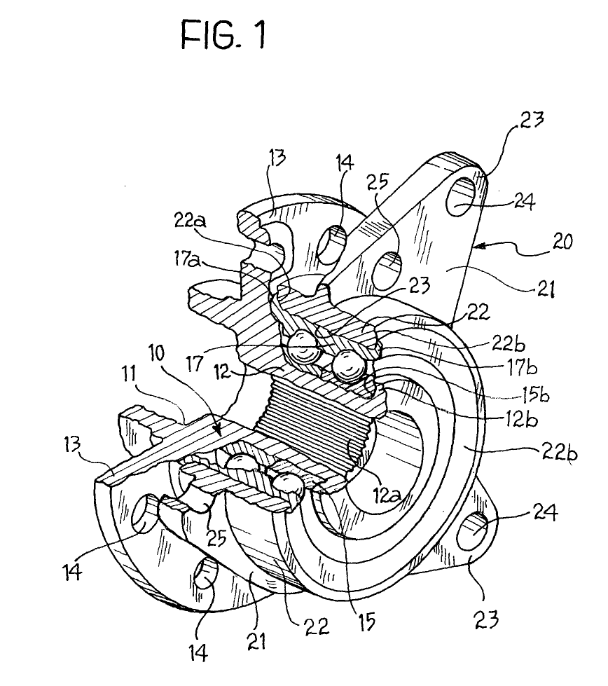

FIG. 1 is a partially cut-away perspective view of a first embodiment of an integral assembly according to the present invention;

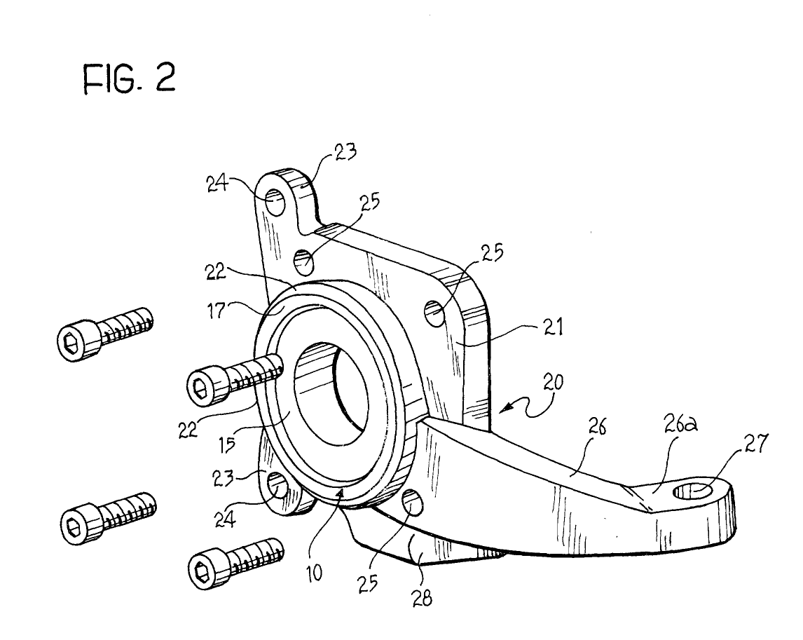

FIG. 2 is a perspective view of a second embodiment of the integral assembly according to the present invention; and

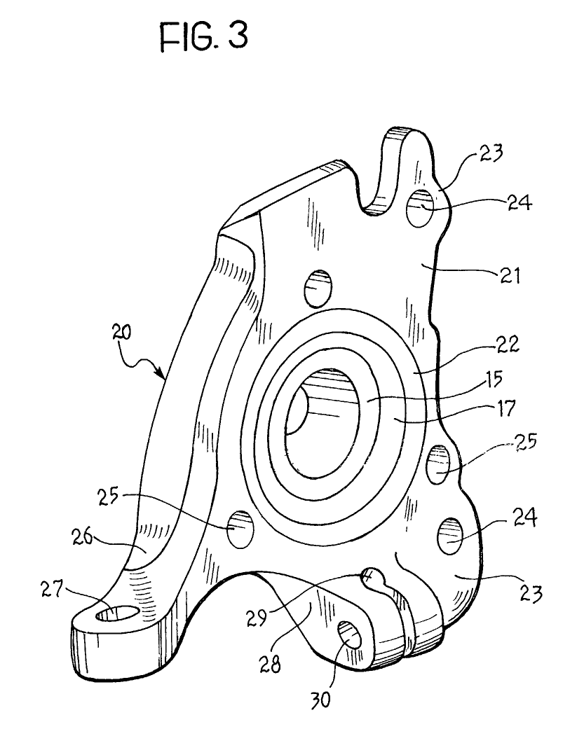

FIG. 3 is a perspective view which shows the other side of the assembly illustrated in FIG. 2.

With initial reference to FIG. 1, the number 10 designates the overall bearing-hub unit for a motor vehicle wheel.

The bearing-hub unit 10 comprises a hub 11 which forms an axial tubular portion 12 with a cylindrical grooved internal surface 12a for connection to a homokinetic coupling (not illustrated). The hub 11 integrally forms a radial flange 13 provided with axial holes 14 for the passage of bolts (not illustrated) which fasten the wheel (not illustrated) and brake rotor (not illustrated), of disk or drum type, rotationally to the hub. As used here, terms and expressions indicating positions and orientations, such as “axial” and “radial”, should be interpreted with reference to the central axis of rotation of the bearing-hub unit 10.

The bearing-hub unit 10 comprises a bearing with a pair of inner half-rings 15, two series of rolling elements 16 (in this example balls) and an outer, non-rotating ring 17. The inner rings 15 of the bearing are locked axially on the tubular portion 12 of the hub by means of one end 12b of the latter which is cold formed, preferably by rolling, being folded back in a radially outward direction against a lateral surface 15b of the inner half-ring 15 located on the axially inner (inboard) side of the vehicle.

The bearing-hub unit 10 is fastened to a metal mounting element which is designated overall 20. The mounting element 20 integrally forms a radial plate portion 21 and a tubular axial portion 22 which is substantially perpendicular to the plate portion 21 and forms a cylindrical seat 23, in which the outer ring 17 of the bearing-hub unit 10 is accommodated and locked.

Axial locking of the outer ring 17 of the bearing in the mounting element 20 is achieved by cold forming, preferably by means of rolling, the ends 17a, 17b of the ring 17; said ends are folded back in radially outward directions against respective lateral faces 22a, 22b of the tubular portion 22.

The plate portion 21 integrally forms a pair of laterally projecting lugs 23 with holes 24 for connection of the brake calipers (not illustrated) capable of cooperating with the brake rotor (not illustrated) mounted on the hub 11.

Formed in the plate 21 are also holes 25 for the passage of bolts (not illustrated in FIG. 1) for fastening the mounting element 20 to the suspension strut.

In the variant illustrated in FIGS. 2 and 3, the mounting element 20 also integrally forms a lateral arm 26 which extends from the side of the plate portion 21 opposite to that comprising the lugs 23 which bear the brake calipers, and an arm 28 which projects downwards.

The lateral arm 26 has, close to the free end 26a thereof, a vertical hole 27 which constitutes a seat for articulation with a steering member (not illustrated) of the vehicle.

As illustrated in FIG. 3, the lower arm 28 comprises a recess 29 for connection to a ball joint (not illustrated) of a suspension arm, not illustrated, and connected to the vehicle in a known manner. The free end of the lower arm 28 is forked and has a horizontal hole 30 capable of accommodating a fastening element (not illustrated) which serves to lock the ball joint in the recess 29.

The mounting element 20 may advantageously be made from a metallic material which differs from, and is less costly than the bearing steel from which the outer ring 17 is made. For example, the metal mounting element 20 may be made from a lighter material such as aluminium and the alloys thereof.

As will be appreciated, integrating the mounts for the brake calipers into the integral flange of the outer ring of the bearing makes it possible to eliminate one of the elements conventionally used at the interface between the bearing-hub unit and the suspension strut, namely the conventional metal plate which comprises mounting lugs for the brake calipers and is locked between the bearing-hub unit and the suspension strut.

It will furthermore be appreciated that, having manufactured the non-rotating ring of the bearing and the mounting element for the brake calipers in two separate elements, the forces generated during braking are transmitted directly from the plate portion 21 to the suspension strut, so bypassing the outer ring 17 of the bearing. More particularly, the stresses generated by braking are consequently not transmitted, except negligibly, to the bearing races of the outer ring of the bearing. In this manner, operation of the bearing is improved and its service life extended.

Naturally, the principle of the invention remaining the same, the forms of embodiment and details of construction may be varied widely with respect to those described and illustrated purely by way of non-limiting examples. For example, the mounting element 20 may obviously be differently shaped, as required, and comprise further means or seats for mounting to the suspension and/or other functional parts of the vehicle.

What is claimed is:

1. An integral assembly for a motor vehicle wheel comprising:
a metal mounting element which integrally forms:
a substantially radial plate portion with seats for fastening to the suspension strut of a motor vehicle and mounting means for brake calipers; and
an axial tubular portion which forms a cylindrical seat;
a bearing-hub unit which includes a hub mounted rotatably in a bearing having a non-rotating, outer ring, locked into the cylindrical seat by means of at least one end portion of the outer ring, which has been cold formed against at least one respective lateral surface of the axial tubular portion.

2. The integral assembly of claim 1, wherein the mounting means for the brake calipers comprise a pair of lugs projecting from one side of the plate portion.

3. The integral assembly of claim 1, wherein the mounting element also integrally forms a lateral arm which projects laterally and has means or seats for articulation with a steering member of the vehicle.

4. The integral assembly of claim 3, wherein the lateral arm extends from a side of the plate portion opposite to that comprising the mounting means for the brake calipers.

5. The integral assembly of claim 1, wherein the mounting element also integrally forms an arm which projects downwards from the plate portion and comprises means or seats for connection to a ball joint of the suspension.

6. The integral assembly of claim 1, wherein the non-rotating, outer ring, is locked into the cylindrical seat by means of two opposing end portions of the outer ring which have been cold formed against two respective opposing lateral surfaces of the axial tubular portion.

7. The integral assembly of claim 1, wherein the mounting element is made from a metallic material which differs from that constituting the outer ring of the bearing.

8. The integral assembly of claim 7, wherein the mounting element is made from aluminium.
